(19) United States
(12) Patent Application Publication
(10) Pub. No.: US 2015/0234623 A1
(43) Pub. Date: Aug. 20, 2015

(54) PRINT-COMMAND SUPPORT DEVICE AND NON-TRANSITORY COMPUTER READABLE MEDIUM

(71) Applicant: FUJI XEROX CO., LTD, Tokyo (JP)

(72) Inventor: Akiko MOCHIZUKI, Kanagawa (JP)

(73) Assignee: FUJI XEROX CO., LTD, Tokyo (JP)

(21) Appl. No.: 14/462,953

(22) Filed: Aug. 19, 2014

(30) Foreign Application Priority Data
Feb. 17, 2014 (JP) 2014-027480

(51) Int. Cl. G06F 3/12

(52) U.S. Cl. CPC G06F 3/1238; G06F 3/1222

(57) ABSTRACT

A print-command support device includes an accepting unit, an authenticating unit, a receiving unit, and a processing unit. The accepting unit accepts user information related to a user of a printing apparatus. The authenticating unit authenticates the user based on the user information. The receiving unit receives request information from a print command device, which displays information related to printing apparatuses and selects one apparatus therefrom to command the apparatus to perform printing. The request information is for requesting transmission of the information related to the apparatus. The processing unit performs a transmission or determination process in accordance with reception of the request information. The transmission process is for transmitting the apparatus-related information and information related to authentication by the authenticating unit to the print command device. The determination process is for determining whether to transmit the apparatus-related information to the print command device based on the authentication-related information.

### CROSS-REFERENCE TO RELATED APPLICATIONS

This application is based on and claims priority under 35 USC 119 from Japanese Patent Application No. 2014-027480 filed Feb. 17, 2014.

### BACKGROUND

### Technical Field

The present invention relates to print-command support devices and non-transitory computer readable media.

### SUMMARY

According to an aspect of the invention, there is provided a print-command support device including an accepting unit, an authenticating unit, a receiving unit, and a processing unit. The accepting unit accepts user information related to a user of a printing apparatus. The authenticating unit authenticates the user based on the user information. The receiving unit receives request information from a print command device, which displays information related to multiple printing apparatuses and selects one printing apparatus from the multiple printing apparatuses so as to command the one printing apparatus to perform printing. The request information is information for requesting transmission of the information related to the printing apparatus. The processing unit performs a transmission process or a determination process in accordance with reception of the request information. The transmission process is a process for transmitting the information related to the printing apparatus and information related to authentication by the authenticating unit to the print command device. The determination process is a process for determining whether to transmit the information related to the printing apparatus to the print command device based on the information related to the authentication by the authenticating unit.

### BRIEF DESCRIPTION OF THE DRAWINGS

Exemplary embodiments of the present invention will be described in detail based on the following figures, wherein:

FIG. 1 illustrates an example of the overall configuration of a printing system according to first and second exemplary embodiments;

FIG. 2 illustrates a list of printer names displayed in a mobile terminal in the first exemplary embodiment;

FIG. 3 illustrates an example of a hardware configuration of an image forming apparatus according to the first exemplary embodiment and a third exemplary embodiment;

FIG. 4 is a block diagram illustrating an example of a functional configuration of an information providing device according to the first and second exemplary embodiments;

FIG. 5 illustrates an example of a hardware configuration of the mobile terminal according to the first, second, and third exemplary embodiments;

FIG. 6 is a flowchart illustrating an example of the operation of the information providing device according to the first exemplary embodiment when authentication information is accepted;

FIG. 7 is a flowchart illustrating an example of the operation of the information providing device according to the first exemplary embodiment when a discovery packet is received;

FIG. 8 illustrates an example of a hardware configuration of an image forming apparatus according to the second exemplary embodiment;

FIG. 9 is a flowchart illustrating an example of the operation of the information providing device according to the second exemplary embodiment when authentication information is accepted;

FIG. 10 is a flowchart illustrating an example of the operation of the information providing device according to the second exemplary embodiment when a discovery packet is received;

FIG. 11 illustrates an example of the overall configuration of a printing system according to the third exemplary embodiment;

FIG. 12 is a block diagram illustrating an example of a functional configuration of an information providing device according to the third exemplary embodiment;

FIG. 13 illustrates an example of a hardware configuration of an authentication server according to the third exemplary embodiment;

FIG. 14 illustrates an example of correspondence information contained in the authentication server according to the third exemplary embodiment; and

FIG. 15 is a flowchart illustrating an example of the operation of the information providing device according to the third exemplary embodiment when authentication information is accepted.

### DETAILED DESCRIPTION

Exemplary embodiments of the present invention will be described below with reference to the appended drawings.

A wireless printing system that combines a discovery protocol, such as a multicast Domain Name System (mDNS), and a printing protocol, such as an Internet Printing Protocol (IPP), is used to search for usable printers every time printing is to be performed from a mobile device and to select a printer to be used for the printing from among the searched printers. In such a wireless printing system, a search request for printers connected to the same sub-network as the mobile device or for printers connected to a wider-range network is normally performed based on the discovery protocol, such as a multicast DNS. Then, based on a response to the search request, a list of connectable printers is displayed in the mobile device. However, if there are many connectable printers in the network, it may sometimes be difficult for a user to determine which printer to use from the displayed list of printers.

In the following exemplary embodiments, the user may readily search for and select a desired printer from the list of multiple printers displayed in the mobile device.

### First Exemplary Embodiment

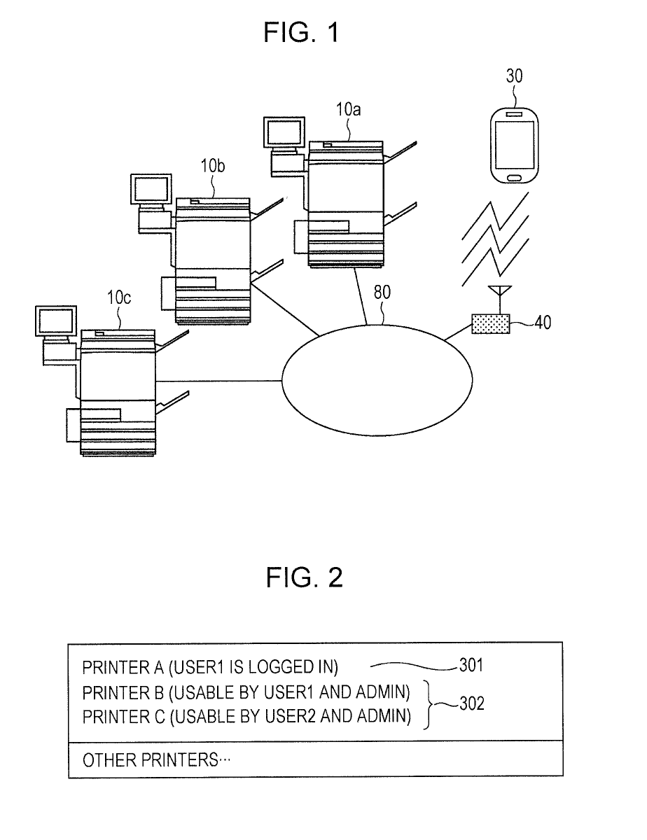

FIG. 1 illustrates an example of the overall configuration of a printing system according to a first exemplary embodiment. As shown in FIG. 1, in this printing system, a mobile terminal 30 is connected via a wireless router 40 to a network 80 to which image forming apparatuses 10a to 10c are connected. If the image forming apparatuses 10a to 10c are not to be differentiated from one another, they will simply be referred to as “image forming apparatus 10”, and the number thereof is not limited to one.

Each of the image forming apparatuses 10a to 10c outputs a printed medium by forming an image onto a recording medium, such as paper. The image forming apparatuses 10a to 10c are in-office shared printers, and a user is authorized to log into one or more of them. Furthermore, the image forming apparatuses 10a to 10c are compatible with wireless printing such that when a user authorized to log into one of the image forming apparatuses 10a to 10c operates the mobile terminal 30 to transmit, for example, document data thereto via the wireless router 40, the image forming apparatus is capable of printing the document data. The image forming apparatus 10 may have the printing function alone, or may have a copying function, a scanning function, a facsimile function, and so on in addition to the printing function. In the first exemplary embodiment, the image forming apparatus 10 is provided as an example of a printing apparatus.

The mobile terminal 30 is a portable terminal device to be used when commanding the image forming apparatus 10 to perform image formation. Moreover, the mobile terminal 30 activates application software that generates, for example, document data based on which an image forming process is to be performed in the image forming apparatus 10. The mobile terminal 30 may be, for example, a smartphone, a notebook-type personal computer (PC), or a tablet PC. In the first exemplary embodiment, the mobile terminal 30 is provided as a print command device.

The wireless router 40 is a relay device for wireless communication between the communication on the network 80 and the mobile terminal 30. The wireless router 40 may be a Wi-Fi (registered trademark) router.

The network 80 is a communication unit used for information communication between the image forming apparatus 10 and the wireless router 40 and is, for example, a local area network (LAN).

The following description relates to a case where a user tries to print a document in any one of the image forming apparatuses 10a to 10c by using the mobile terminal 30 in this printing system. In this case, the mobile terminal 30 searches for a usable image forming apparatus 10 in the vicinity thereof. In this search, the mobile terminal 30 normally sends a search packet of the discovery protocol, such as a multicast DNS, based on multicast, and the image forming apparatus 10 receiving this search packet responds based on multicast by sending, for example, an apparatus name (i.e., printer name) and apparatus capability information.

In this case, in the first exemplary embodiment, the image forming apparatus 10 performs first operation in which the image forming apparatus 10 responds by generating a printer name containing a logged-in username if there is a logged-in user or responds by generating a printer name containing a username capable of logging in if there is no logged-in user.

FIG. 2 illustrates a list of printer names displayed in the mobile terminal 30 based on such a response. In FIG. 2, a printer name 301 corresponds to a printer name in the former case, whereas printer names 302 correspond to printer names in the latter case.

Furthermore, in the first exemplary embodiment, if there is no logged-in user or if there is a logged-in user, second operation in which a response is not sent back by ignoring the search request may also be performed.

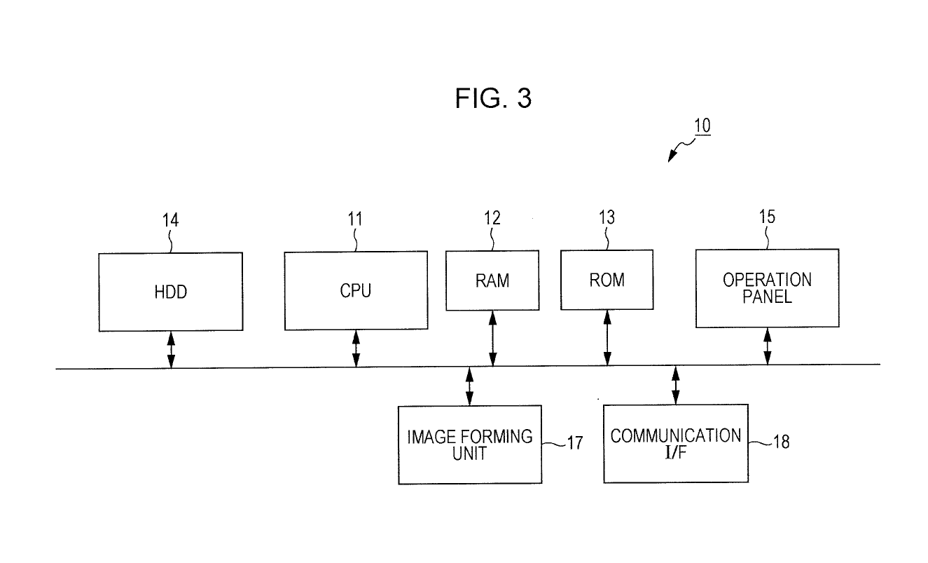

FIG. 3 illustrates an example of a hardware configuration of the image forming apparatus 10 according to the first exemplary embodiment. As shown in FIG. 3, the image forming apparatus 10 includes a central processing unit (CPU) 11, a random access memory (RAM) 12, a read-only memory (ROM) 13, a hard disk drive (HDD) 14, an operation panel 15, an image forming unit 17, and a communication interface (referred to as “communication I/F” hereinafter) 18.

The CPU 11 loads various kinds of programs stored in, for example, the ROM 13 into the RAM 12 and executes the programs so as to realize functions to be described below.

The RAM 12 is used as, for example, a working-space memory by the CPU 11.

The ROM 13 stores, for example, the various kinds of programs to be executed by the CPU 11.

The HDD 14 is, for example, a magnetic disk device that stores image data and the like to be used in an image forming process in the image forming unit 17.

The operation panel 15 is a touch-screen that displays various kinds of information and that also accepts operation input from a user. The operation panel 15 includes a display on which various kinds of information are displayed and a position detection sheet that detects a position designated using, for example, a finger or a stylus pen. Alternatively, a display and a keyboard may be used in place of a touch-screen.

The image forming unit 17 forms an image onto a recording medium. The image forming unit 17 is, for example, a printer and may be of an electrophotographic type that forms an image by transferring toner adhered on a photoconductor onto a recording medium or an inkjet type that forms an image by ejecting ink onto a recording medium.

The communication I/F 18 exchanges various kinds to information with other apparatuses via the network 80.

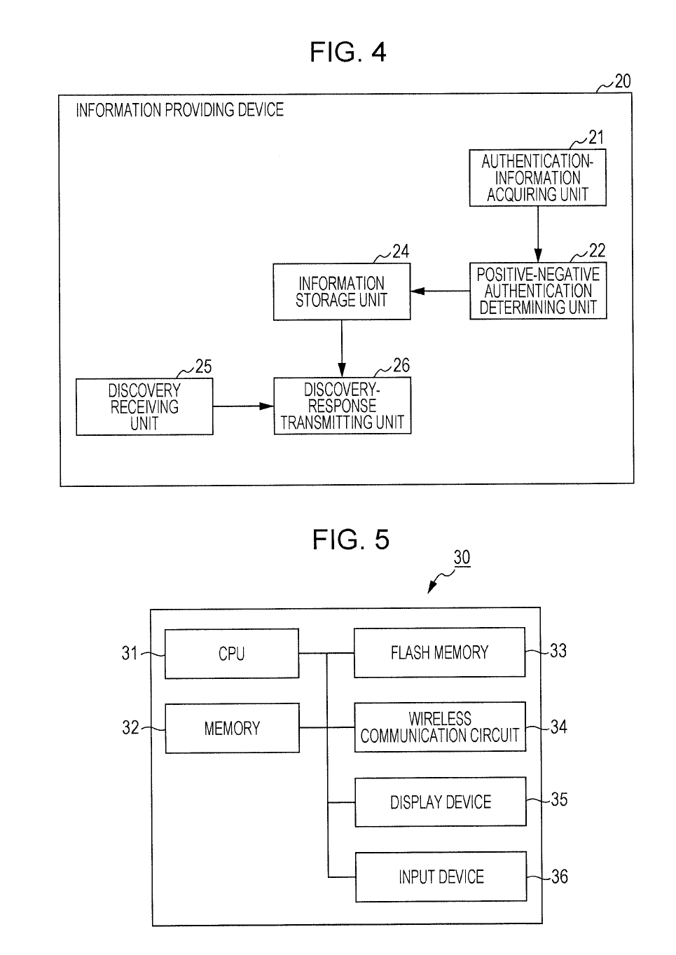

FIG. 4 is a block diagram illustrating an example of a functional configuration of an information providing device 20 as an example of a print-command support device according to the first exemplary embodiment. The information providing device 20 according to the first exemplary embodiment is considered as a device realized by the CPU 11 (see FIG. 3) loading programs, which realize functional units to be described later, from the ROM 13 (see FIG. 3) into the RAM 12 (see FIG. 3) and executing the programs in the image forming apparatus 10 according to the first exemplary embodiment.

As shown in FIG. 4, the information providing device 20 according to the first exemplary embodiment includes an authentication-information acquiring unit 21, a positive-negative authentication determining unit 22, an information storage unit 24, a discovery receiving unit 25, and a discovery-response transmitting unit 26.

The authentication-information acquiring unit 21 acquires authentication information (i.e., user ID and password) input to, for example, the operation panel 15 by a user. In the first exemplary embodiment, the authentication information is used as an example of user information related to the user using the printing apparatus, and the authentication-information acquiring unit 21 is provided as an example of an accepting unit that accepts the user information.

The positive-negative authentication determining unit 22 determines whether the user is capable of logging into the apparatus and using the apparatus based on the authentication information acquired by the authentication-information acquiring unit 21. Then, if it is determined that the user is capable of logging into the apparatus and using the apparatus, the positive-negative authentication determining unit 22 outputs the user ID of the user to the information storage unit 24. In the first exemplary embodiment, the positive-negative authentication determining unit 22 is provided as an example of an authenticating unit that authenticates the user.

The information storage unit 24 stores the user ID output from the positive-negative authentication determining unit 22. In other words, the information storage unit 24 stores the user ID of the currently logged-in user.

The discovery receiving unit 25 receives a search packet of the discovery protocol (referred to as “discovery packet” hereinafter) from the mobile terminal 30 via the communication I/F 18. In the first exemplary embodiment, the discovery packet is used as an example of request information for requesting transmission of information related to the printing apparatus, and the discovery receiving unit 25 is provided as an example of a receiving unit that receives the request information.

When the discovery receiving unit 25 receives the discovery packet, if the first operation is to be performed, the discovery-response transmitting unit 26 generates a response to the discovery packet (referred to as “discovery response” hereinafter) and transmits the discovery response to the mobile terminal 30. In this case, the printer name of the apparatus is contained in the discovery response, and the user ID stored in the information storage unit 24 is contained in this printer name. Furthermore, if the second operation is to be performed, the discovery-response transmitting unit 26 determines whether to transmit the discovery response to the mobile terminal 30 based on information stored in the information storage unit 24. Specifically, if the user ID is stored in the information storage unit 24, the discovery-response transmitting unit 26 determines to transmit the discovery response to the mobile terminal 30, and if the user ID is not stored in the information storage unit 24, the discovery-response transmitting unit 26 determines not to transmit the discovery response to the mobile terminal 30. Alternatively, if the user ID is not stored in the information storage unit 24, the discovery-response transmitting unit 26 determines to transmit the discovery response to the mobile terminal 30, and if the user ID is stored in the information storage unit 24, the discovery-response transmitting unit 26 determines not to transmit the discovery response to the mobile terminal 30. In the first exemplary embodiment, the printer name is used as an example of information related to the printing apparatus, and the user ID is used as an example of information related to authentication by the authenticating unit. Furthermore, if the first operation is to be performed, the discovery-response transmitting unit 26 is provided as an example of a processing unit that performs a transmission process for transmitting the information related to the printing apparatus and the information related to authentication by the authenticating unit to the print command device. If the second operation is to be performed, the discovery-response transmitting unit 26 is provided as an example of a processing unit that performs a determination process for determining whether to transmit the information related to the printing apparatus to the print command device based on the information related to authentication by the authenticating unit.

FIG. 5 illustrates an example of a hardware configuration of the mobile terminal 30 according to the first exemplary embodiment. As shown in FIG. 5, the mobile terminal 30 includes a CPU 31, a memory 32, a flash memory 33, a wireless communication circuit 34, a display device 35, and an input device 36.

The CPU 31 loads various kinds of programs stored in the flash memory 33 into the memory 32 and executes the programs so as to realize the function of the mobile terminal 30.

The memory 32 is used as, for example, a working-space memory by the CPU 31.

The flash memory 33 stores, for example, the various kinds of programs to be executed by the CPU 31 as well as data generated or acquired by the mobile terminal 30.

The wireless communication circuit 34 exchanges various kinds of information with the wireless router 40 (see FIG. 1) by using an antenna (not shown). The wireless communication circuit 34 may include, for example, a baseband processor that performs processing related to telephone calls and communication, as well as a Wi-Fi (registered trademark) module that performs processing for Wi-Fi (registered trademark) communication.

The display device 35 displays various kinds of information output from within the mobile terminal 30. The display device 35 may be, for example, a liquid crystal display.

The input device 36 receives information input by the user and inputs the information into the mobile terminal 30. The input device 36 may be, for example, a touch sensor that detects a position touched with a finger, a stylus pen, or the like.

Next, the operation according to the first exemplary embodiment will be described. The aforementioned first operation will be described below.

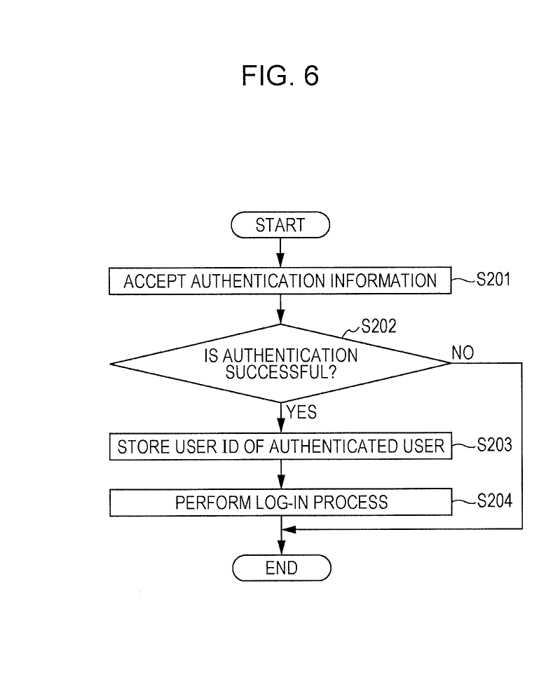

First, the operation corresponding to when authentication information is input by the user via, for example, the operation panel 15 will be described. FIG. 6 is a flowchart illustrating an example of the operation of the information providing device 20 in this case.

As shown in FIG. 6, in step 201, the authentication-information acquiring unit 21 in the information providing device 20 acquires the authentication information input via, for example, the operation panel 15.

Then, in step 202, the positive-negative authentication determining unit 22 authenticates the user based on the authentication information acquired in step 201. In other words, it is determined whether the user is capable of logging into the apparatus.

If the user authentication is successful, that is, if it is determined that the user is capable of logging into the apparatus, the positive-negative authentication determining unit 22 stores the user ID acquired in step 201 into the information storage unit 24 as the user ID of the logged-in user in step 203. Then, in step 204, a log-in process is performed for that user.

On the other hand, if the user authentication is not successful in step 202, that is, if it is determined that the user is not capable of logging into the apparatus, the processing ends.

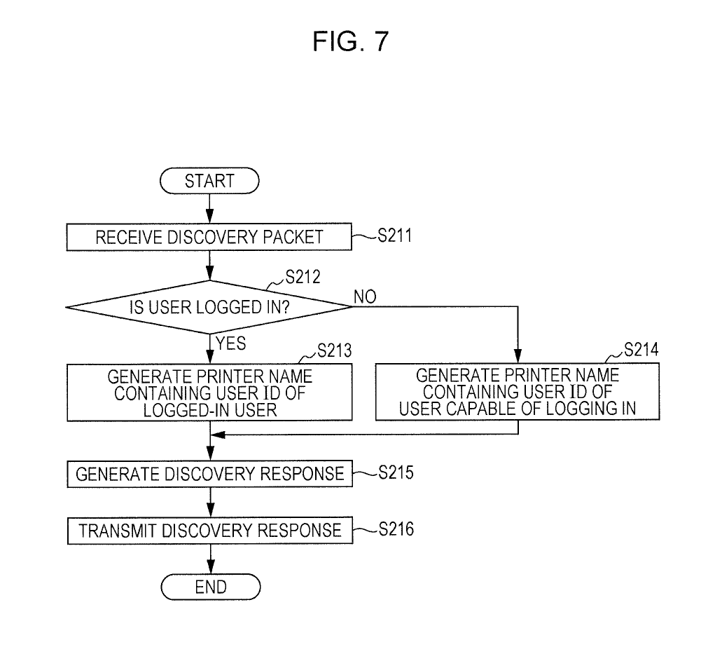

Subsequently, it is assumed that a discovery packet for performing printing is transmitted by the mobile terminal 30 and is received by the image forming apparatus 10. FIG. 7 is a flowchart illustrating an example of the operation of the information providing device 20 in this case.

As shown in FIG. 7, in step 211, the discovery receiving unit 25 in the information providing device 20 receives the discovery packet from the mobile terminal 30 via the communication I/F 18.

Then, in step 212, the discovery-response transmitting unit 26 determines whether any one of users is logged into the apparatus. Specifically, it is determined whether the user ID of any one of the users is stored in the information storage unit 24.

If it is determined that any one of the users is logged into the apparatus, the discovery-response transmitting unit 26 generates a printer name containing the user ID of the logged-in user in step 213. Specifically, the user ID is read from the information storage unit 24 and is set into a portion of a preliminarily-acquired printer name of the apparatus.

On the other hand, if it is determined in step 212 that none of the users is logged into the apparatus, the discovery-response transmitting unit 26 generates a printer name containing a user ID of a user capable of logging into the apparatus in step 214. Specifically, the user ID is read from a storage area in which the user ID of the user capable of logging into the apparatus is stored, and is set into a portion of the preliminarily-acquired printer name of the apparatus.

When the printer name is generated in step 213 or 214, the discovery-response transmitting unit 26 generates a discovery response containing this printer name in step 215. Then, in step 216, the discovery response is transmitted to the mobile terminal 30.

In this operational example, the discovery response contains the user ID of an authenticated user. Alternatively, for example, the discovery response may contain, for example, an icon or a character string indicating that any one of the users is logged in. As another alternative, the discovery response may contain, for example, an icon designated by a user or a character string indicating an organization to which a user belongs. Furthermore, due to security reasons, it may sometimes be problematic if the user ID of the logged-in user is revealed to another user. In that case, it may be effective to preregister, for example, a character string that allows the logged-in user to identify himself/herself but does not allow another user to identify the logged-in user, and to contain this character string in the printer name.

Although the flowcharts shown in FIGS. 6 and 7 correspond to the first operation, the second operation is also realized by slightly changing the above-described processing content. In detail, when the user inputs authentication information via, for example, the operation panel 15, the operation shown in FIG. 6 may be performed. Subsequently, with regard to the operation performed when a discovery packet for performing printing is transmitted by the mobile terminal 30 and is received by the image forming apparatus 10, step 213 and onward in FIG. 7 may be changed as follows. Specifically, if the discovery-response transmitting unit 26 determines that any one of the users is logged into the apparatus, the discovery-response transmitting unit 26 generates a discovery response containing the printer name and transmits the discovery response to the mobile terminal 30. If the discovery-response transmitting unit 26 determines that none of the users is logged into the apparatus, the discovery-response transmitting unit 26 does not transmit the discovery response to the mobile terminal 30. Alternatively, step 213 and onward in FIG. 7 may be changed as follows. Specifically, if the discovery-response transmitting unit 26 determines that none of the users is logged into the apparatus, the discovery-response transmitting unit 26 generates a discovery response containing the printer name and transmits the discovery response to the mobile terminal 30. If the discovery-response transmitting unit 26 determines that any one of the users is logged into the apparatus, the discovery-response transmitting unit 26 does not transmit the discovery response to the mobile terminal 30.

The first exemplary embodiment does not mention connecting to an authentication server when the positive-negative authentication determining unit 22 authenticates a user. This is because it is assumed that a user database (DB) for user authentication exists within the image forming apparatus 10. However, a configuration that authenticates a user by connecting to an authentication server may alternatively be employed.

### Second Exemplary Embodiment

Since the overall configuration of a printing system according to a second exemplary embodiment is the same as that in the first exemplary embodiment, a description thereof is omitted. However, in the second exemplary embodiment, the image forming apparatus 10 to be used by a user includes an authentication-information reading device, which will be described later.

The mobile terminal 30 used by the user contains authentication information (i.e., user ID and password) for logging into the image forming apparatus 10. The user logs into the image forming apparatus 10 by holding the mobile terminal 30 to the authentication-information reading device of the image forming apparatus 10 before printing a document from the mobile terminal 30. In this case, the authentication-information reading device reads and stores a media access control (MAC) address of the mobile terminal 30 in addition to the authentication information of the user.

Subsequently, while the logged-in state of the image forming apparatus 10 is maintained, the user searches for the image forming apparatus 10 by using the mobile terminal 30 used for the log-in. The discovery protocol used for searching for the image forming apparatus 10 is generally implemented by using a user datagram protocol (UDP), and the MAC address of the mobile terminal 30 is contained within the header.

When the image forming apparatus 10 receives a search request of the discovery protocol, the image forming apparatus 10 compares the MAC address of the mobile terminal 30 read during the log-in by the user with a MAC address contained in the search request, and responds to the search request only if the MAC addresses match.

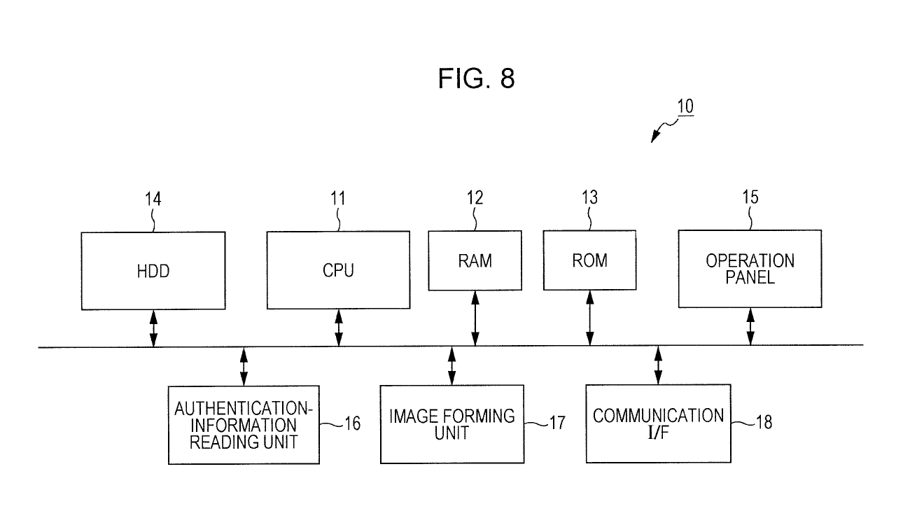

FIG. 8 illustrates an example of a hardware configuration of the image forming apparatus 10 according to the second exemplary embodiment. As shown in FIG. 8, the image forming apparatus 10 includes a CPU 11, a RAM 12, a ROM 13, an HDD 14, an operation panel 15, an authentication-information reading unit 16, an image forming unit 17, and a communication I/F 18.

Since the CPU 11, the RAM 12, the ROM 13, the HDD 14, the operation panel 15, the image forming unit 17, and the communication I/F 18 are the same as those described in the first exemplary embodiment, descriptions thereof are omitted here.

The authentication-information reading unit 16 corresponds to the aforementioned authentication-information reading device and reads the authentication information from the mobile terminal 30 when the mobile terminal 30 is held thereto. The authentication-information reading unit 16 may be of a type that uses the mechanism of an integrated-circuit (IC) card reader, such as FeliCa (registered trademark), or may be a QR code (registered trademark) reader.

An example of a functional configuration of an information providing device 20 as an example of a print-command support device according to the second exemplary embodiment is the same as that shown in FIG. 4. The information providing device 20 according to the second exemplary embodiment is considered as a device realized by the CPU 11 (see FIG. 8) loading programs, which realize functional units to be described later, from the ROM 13 (see FIG. 8) to the RAM 12 (see FIG. 8) and executing the programs in the image forming apparatus 10 according to the second exemplary embodiment.

As shown in FIG. 4, the information providing device 20 according to the second exemplary embodiment includes an authentication-information acquiring unit 21, a positive-negative authentication determining unit 22, an information storage unit 24, a discovery receiving unit 25, and a discovery-response transmitting unit 26.

The authentication-information acquiring unit 21 acquires the authentication information and the MAC address input thereto when the user holds the mobile terminal 30 to the authentication-information reading unit 16. In the second exemplary embodiment, the authentication information is an example of user information related to the user using the printing apparatus, and the authentication-information acquiring unit 21 is provided as an example of an accepting unit that accepts the user information.

The positive-negative authentication determining unit 22 determines whether the user is capable of logging into the apparatus and using the apparatus based on the authentication information acquired by the authentication-information acquiring unit 21. Then, if it is determined that the user is capable of logging into the apparatus and using the apparatus, the MAC address acquired by the authentication-information acquiring unit 21 is stored into the information storage unit 24. In the second exemplary embodiment, the positive-negative authentication determining unit 22 is provided as an example of an authenticating unit that authenticates the user.

The information storage unit 24 stores the MAC address output from the positive-negative authentication determining unit 22. In other words, the information storage unit 24 stores the MAC address of the mobile terminal 30 belonging to the currently logged-in user. In the second exemplary embodiment, the MAC address is used as an example of first information, which is information related to the device belonging to the user, and the information storage unit 24 is provided as an example of a storage unit that stores the first information.

The discovery receiving unit 25 receives a search packet of the discovery protocol (referred to as “discovery packet” hereinafter) from the mobile terminal 30 via the communication I/F 18. This discovery packet contains the MAC address. In the second exemplary embodiment, the MAC address is used as an example of second information, which is information related to the print command device, the discovery packet is used as an example of request information, which is information for requesting transmission of information related to the printing apparatus and contains the second information, and the discovery receiving unit 25 is provided as an example of a receiving unit that receives the request information.

When the discovery receiving unit 25 receives the discovery packet, the discovery-response transmitting unit 26 determines whether to transmit, to the mobile terminal 30, a response (i.e., discovery response) to the discovery packet based on a comparison result between the MAC address received by the discovery receiving unit 25 and the MAC address stored in the information storage unit 24. Specifically, if these MAC addresses match, the discovery-response transmitting unit 26 determines to transmit the discovery response to the mobile terminal 30, and if these MAC addresses do not match, the discovery-response transmitting unit 26 determines not to transmit the discovery response to the mobile terminal 30. In the second exemplary embodiment, the discovery-response transmitting unit 26 is provided as an example of a determining unit that determines whether to transmit the information related to the printing apparatus to the print command device based on a comparison result between the first information and the second information.

Since the hardware configuration of the mobile terminal 30 according to the second exemplary embodiment is the same as that in the first exemplary embodiment, a description thereof is omitted. However, as mentioned above, the mobile terminal 30 contains authentication information for logging into the image forming apparatus 10.

Next, the operation according to the second exemplary embodiment will be described.

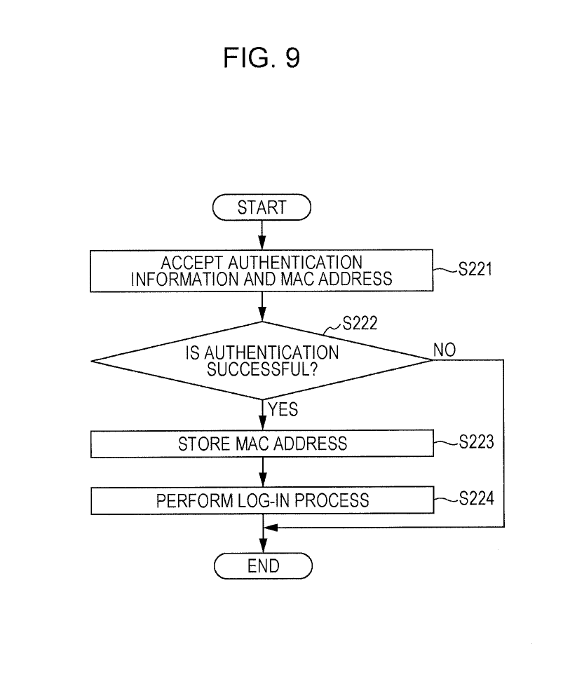

First, the operation corresponding to when authentication information is input by the user holding the mobile terminal 30 to the authentication-information reading unit 16 will be described. FIG. 9 is a flowchart illustrating an example of the operation of the information providing device 20 in this case.

As shown in FIG. 9, in step 221, the authentication-information acquiring unit 21 in the information providing device 20 acquires the authentication information and the MAC address input from the authentication-information reading unit 16.

Then, in step 222, the positive-negative authentication determining unit 22 authenticates the user based on the authentication information acquired in step 221. In other words, it is determined whether the user is capable of logging into the apparatus.

If the user authentication is successful, that is, if it is determined that the user is capable of logging into the apparatus, the positive-negative authentication determining unit 22 stores the MAC address acquired in step 221 into the information storage unit 24 as the MAC address of the mobile terminal 30 belonging to the logged-in user in step 223. Then, in step 224, a log-in process is performed for that user.

On the other hand, if the user authentication is not successful in step 222, that is, if it is determined that the user is not capable of logging into the apparatus, the processing ends.

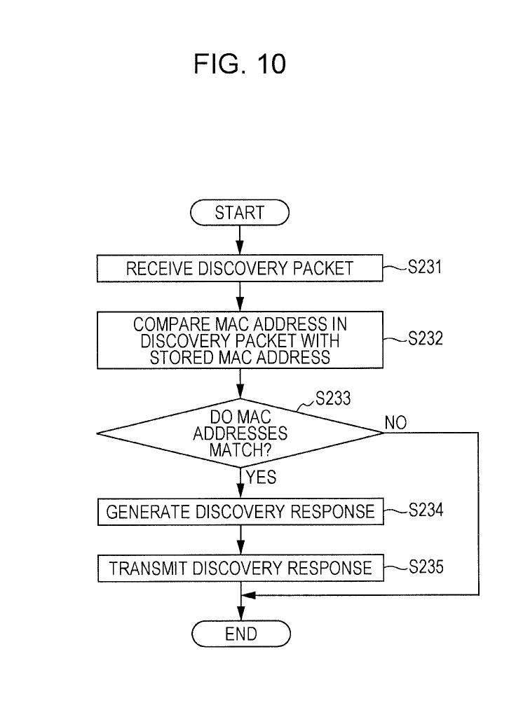

Subsequently, it is assumed that a discovery packet for performing printing is transmitted by the mobile terminal 30 and is received by the image forming apparatus 10. FIG. 10 is a flowchart illustrating an example of the operation of the information providing device 20 in this case.

As shown in FIG. 10, in step 231, the discovery receiving unit 25 in the information providing device 20 receives the discovery packet from the mobile terminal 30 via the communication I/F 18.

Then, in step 232, the discovery-response transmitting unit 26 compares the MAC address contained in the discovery packet received in step 231 with the MAC address stored in step 223 in FIG. 9. In step 233, the discovery-response transmitting unit 26 determines whether these MAC addresses match.

If it is determined that the MAC addresses match, the discovery-response transmitting unit 26 generates a discovery response containing the printer name of the apparatus in step 234, and transmits the discovery response to the mobile terminal 30 in step 235.

On the other hand, if it is determined in step 233 that the MAC addresses do not match, the processing ends.

In this operational example, the MAC address contained in the discovery packet and the MAC address stored in the information storage unit 24 are compared with each other. Alternatively, IP addresses or host names may be compared instead of MAC addresses.

Furthermore, in this operational example, MAC addresses are compared since it is assumed that the discovery packet does not contain a user ID. Alternatively, if the discovery packet contains a user ID based on a protocol, user IDs may be compared instead of MAC addresses. Specifically, during user authentication, the positive-negative authentication determining unit 22 stores the user ID of the logged-in user into the information storage unit 24. In this case, the user ID is used as an example of first information, which is information related to the user. Furthermore, when the discovery packet is received, the discovery-response transmitting unit 26 compares the user ID contained in the discovery packet with the user ID stored in the information storage unit 24 and transmits a discovery response to the mobile terminal 30 only when these user IDs match. In this case, the user ID is used as an example of second information, which is information related to the owner of the print command device.

Alternatively, the discovery-response transmitting unit 26 may compare the user ID stored in the information storage unit 24 with the MAC address contained in the discovery packet, or compare the MAC address stored in the information storage unit 24 with the user ID contained in the discovery packet. This implies that a MAC address may be used as an example of second information when a user ID is used as an example of first information, or a user ID may be used as an example of second information when a MAC address is used as an example of first information. However, in either case, a process for acquiring a MAC address corresponding to a user ID based on the user ID or a process for acquiring a user ID corresponding to a MAC address based on the MAC address is performed at an appropriate timing.

Furthermore, the discovery-response transmitting unit 26 may determine whether the user performing a discovery request from the mobile terminal 30 is capable of logging into the apparatus based on information such as the user ID contained in the discovery packet, and may transmit a discovery response to the mobile terminal 30 only when the user is capable of logging in. Alternatively, the discovery-response transmitting unit 26 may determine whether the user performing a discovery request from the mobile terminal 30 is authorized to use the apparatus and may transmit a discovery response to the mobile terminal 30 only when the user is authorized.

The second exemplary embodiment does not mention connecting to an authentication server when the positive-negative authentication determining unit 22 authenticates a user. This is because it is assumed that a user DB for user authentication exists within the image forming apparatus 10. However, a configuration that authenticates a user by connecting to an authentication server may alternatively be employed.

### Third Exemplary Embodiment

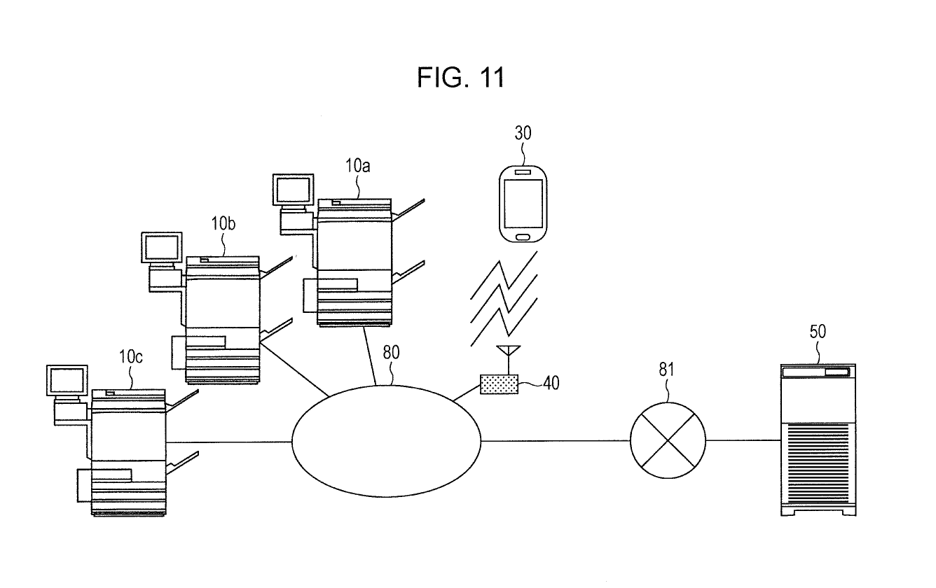

FIG. 11 illustrates an example of the overall configuration of a printing system according to a third exemplary embodiment. As shown in FIG. 11, in this printing system, a mobile terminal 30 is connected via a wireless router 40 to a network 80 to which image forming apparatuses 10a to 10c are connected. If the image forming apparatuses 10a to 10c are not to be differentiated from one another, they will simply be referred to as “image forming apparatus 10”, and the number thereof is not limited to one. The network 80 is also connected to an authentication server 50. The authentication server 50 does not necessarily have to be directly connected to the network 80. In FIG. 11, the authentication server 50 is connected to the network 80 via a network 81.

Since the image forming apparatus 10, the mobile terminal 30, the wireless router 40, and the network 80 are the same as those described in the first exemplary embodiment, descriptions thereof are omitted here.

The authentication server 50 is a server computer that provides information about the mobile terminal 30 belonging to a user in response to a request from the image forming apparatus 10.

The network 81 is a communication unit used for information communication between the network 80 and the authentication server 50 and is, for example, the Internet.

The user logs into the image forming apparatus 10 with his/her account. Specifically, the user inputs a user ID and a password into the image forming apparatus 10. In this case, the user ID and the password may be input by using an information reading device as in the second exemplary embodiment or may be input from the operation panel 15 of the image forming apparatus 10. The image forming apparatus 10 refers to the authentication server 50 by using the input username and password so as to determine whether the user is capable of logging in.

In this case, the image forming apparatus 10 acquires, from the authentication server 50, a preregistered MAC address of the mobile terminal 30 belonging to the user in addition to the information indicating whether the user is capable of logging in.

Subsequently, the user searches for the image forming apparatus 10 from the mobile terminal 30, as in the second exemplary embodiment. When the image forming apparatus 10 receives a search request of the discovery protocol, the image forming apparatus 10 compares the MAC address of the mobile terminal 30 acquired from the authentication server 50 with a MAC address contained in the search request, and responds to the search request only if the MAC addresses match.

Since the hardware configuration of the image forming apparatus 10 according to the third exemplary embodiment is the same as that in the first exemplary embodiment, a description thereof is omitted.

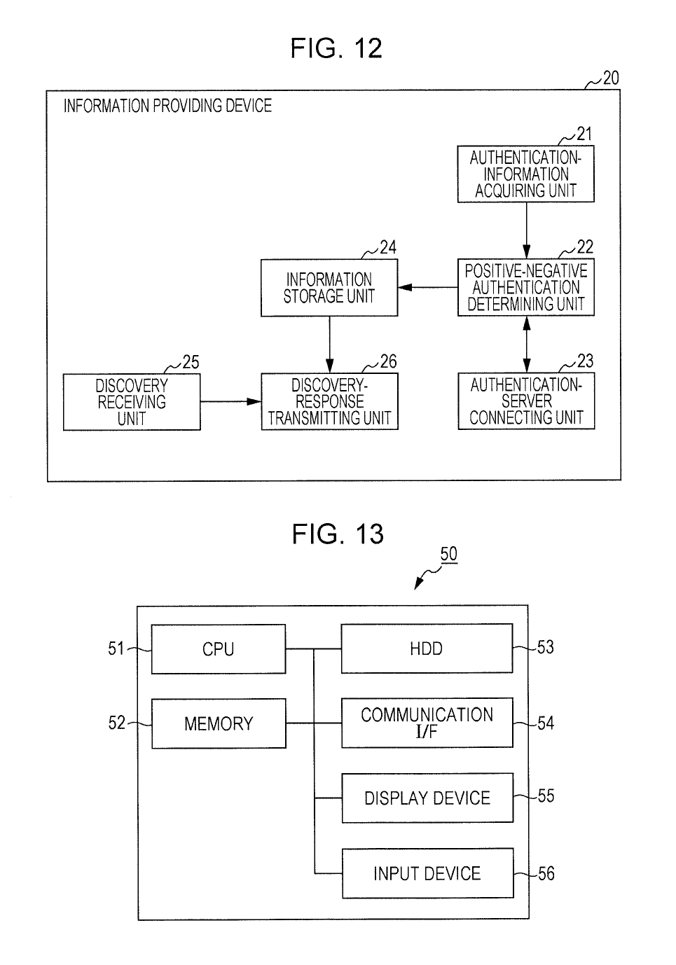

FIG. 12 is a block diagram illustrating an example of a functional configuration of an information providing device 20 as an example of a print-command support device according to the third exemplary embodiment. The information providing device 20 according to the third exemplary embodiment is considered as a device realized by the CPU 11 (see FIG. 3) loading programs, which realize functional units to be described later, from the ROM 13 (see FIG. 3) into the RAM 12 (see FIG. 3) and executing the programs in the image forming apparatus 10 according to the third exemplary embodiment.

As shown in FIG. 12, the information providing device 20 according to the third exemplary embodiment includes an authentication-information acquiring unit 21, a positive-negative authentication determining unit 22, an authentication-server connecting unit 23, an information storage unit 24, a discovery receiving unit 25, and a discovery-response transmitting unit 26.

The authentication-information acquiring unit 21 acquires authentication information (i.e., user ID and password) input to, for example, the operation panel 15 by a user. In the third exemplary embodiment, the authentication information is used as an example of user information related to the user using the printing apparatus, and the authentication-information acquiring unit 21 is provided as an example of an accepting unit that accepts the user information.

The positive-negative authentication determining unit 22 outputs the user ID acquired by the authentication-information acquiring unit 21 to the authentication-server connecting unit 23 so as to acquire a MAC address of the mobile terminal 30 belonging to that user from the authentication-server connecting unit 23. Furthermore, the positive-negative authentication determining unit 22 determines whether the user is capable of logging into the apparatus and using the apparatus by outputting the authentication information acquired by the authentication-information acquiring unit 21 to the authentication-server connecting unit 23. Then, if it is determined that the user is capable of logging into the apparatus and using the apparatus, the positive-negative authentication determining unit 22 outputs the MAC address acquired from the authentication-server connecting unit 23 to the information storage unit 24. In the third exemplary embodiment, the positive-negative authentication determining unit 22 is provided as an example of an authenticating unit that authenticates the user.

The authentication-server connecting unit 23 refers to the authentication server 50 by using the user ID received from the positive-negative authentication determining unit 22 so as to receive the MAC address of the mobile terminal 30 belonging to the user from the authentication server 50. Furthermore, the authentication-server connecting unit 23 refers to the authentication server 50 by using the authentication information received from the positive-negative authentication determining unit 22 so as to receive, from the authentication server 50, information indicating whether the user is capable of logging into the apparatus and using the apparatus.

The information storage unit 24 stores the MAC address output from the positive-negative authentication determining unit 22. In other words, the information storage unit 24 stores the MAC address of the mobile terminal 30 belonging to the currently logged-in user. In the third exemplary embodiment, the MAC address is used as an example of first information, which is information related to the device belonging to the user, and the information storage unit 24 is provided as an example of a storage unit that stores the first information.

The discovery receiving unit 25 receives a search packet of the discovery protocol (referred to as “discovery packet” hereinafter) from the mobile terminal 30 via the communication I/F 18. This discovery packet contains the MAC address. In the third exemplary embodiment, the MAC address is used as an example of second information, which is information related to the print command device, the discovery packet is used as an example of request information, which is information for requesting transmission of information related to the printing apparatus and contains the second information, and the discovery receiving unit 25 is provided as an example of a receiving unit that receives the request information.

When the discovery receiving unit 25 receives the discovery packet, the discovery-response transmitting unit 26 determines whether to transmit, to the mobile terminal 30, a response (i.e., discovery response) to the discovery packet based on a comparison result between the MAC address received by the discovery receiving unit 25 and the MAC address stored in the information storage unit 24. Specifically, if these MAC addresses match, the discovery-response transmitting unit 26 determines to transmit the discovery response to the mobile terminal 30, and if these MAC addresses do not match, the discovery-response transmitting unit 26 determines not to transmit the discovery response to the mobile terminal 30. In the third exemplary embodiment, the discovery-response transmitting unit 26 is provided as an example of a determining unit that determines whether to transmit the information related to the printing apparatus to the print command device based on a comparison result between the first information and the second information.

Since the hardware configuration of the mobile terminal 30 according to the third exemplary embodiment is the same as that in the first exemplary embodiment, a description thereof is omitted.

FIG. 13 illustrates an example of a hardware configuration of the authentication server 50 according to the third exemplary embodiment. As shown in FIG. 13, the authentication server 50 includes a CPU 51, a memory 52, an HDD 53, a communication I/F 54, a display device 55, and an input device 56.

The CPU 51 loads various kinds of programs stored in, for example, the HDD 53 into the memory 52 and executes the programs so as to realize the function of the authentication server 50.

The memory 52 is used as, for example, a working-space memory by the CPU 51.

The HDD 53 is a memory that stores, for example, the various kinds of programs to be executed by the CPU 51 as well as data generated or acquired by the authentication server 50.

The communication I/F 54 exchanges various kinds of information with other apparatuses via the network 81.

The display device 55 displays various kinds of information output from within the authentication server 50. The display device 55 may be, for example, a liquid crystal display.

The input device 56 receives information input by the user and inputs the information into the authentication server 50.

Although not shown, the authentication server 50 according to the third exemplary embodiment may at least include a storage unit that stores correspondence information between a user ID of a user and a MAC address of a mobile terminal 30 belong to that user, a receiving unit that receives the user ID from the image forming apparatus 10, and a transmitting unit that transmits the MAC address corresponding to the user ID, received by the receiving unit, in the correspondence information.

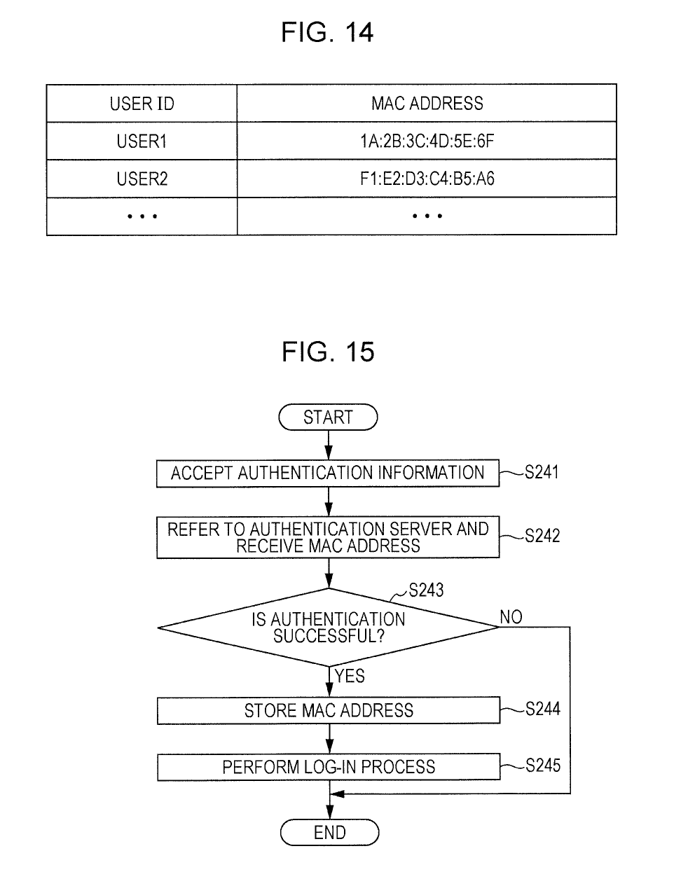

FIG. 14 illustrates an example of terminal information contained in the authentication server 50. In FIG. 14, a mobile terminal 30 belonging to a user with a user ID “user1” has a MAC address “1A:2B:3C:4D:5E:6F”, and a mobile terminal 30 belonging to a user with a user ID “user2” has a MAC address “F1:E2:D3:C4:B5:A6”.

Next, the operation according to the third exemplary embodiment will be described.

First, the operation corresponding to when authentication information is input by a user via, for example, the operation panel 15 will be described. FIG. 15 is a flowchart illustrating an example of the operation of the information providing device 20 in this case.

As shown in FIG. 15, in step 241, the authentication-information acquiring unit 21 in the information providing device 20 acquires the authentication information input via, for example, the operation panel 15.

Then, in step 242, the positive-negative authentication determining unit 22 outputs a user ID contained in the authentication information acquired in step 241 to the authentication-server connecting unit 23, and the authentication-server connecting unit 23 refers to the authentication server 50 by using the user ID so as to receive a MAC address of the mobile terminal 30 belonging to the user. Furthermore, in step 243, the positive-negative authentication determining unit 22 outputs the authentication information acquired in step 241 to the authentication-server connecting unit 23, and the authentication-server connecting unit 23 refers to the authentication server 50 by using the user ID so as to authenticate the user. In other words, it is determined whether the user is capable of logging into the apparatus.

If the user authentication is successful, that is, if it is determined that the user is capable of logging into the apparatus, the positive-negative authentication determining unit 22 stores the MAC address received in step 242 into the information storage unit 24 as the MAC address of the mobile terminal 30 belonging to the logged-in user in step 244. Then, in step 245, a log-in process is performed for that user.

On the other hand, if the user authentication is not successful in step 243, that is, if it is determined that the user is not capable of logging into the apparatus, the processing ends.

Subsequently, it is assumed that a discovery packet for performing printing is transmitted by the mobile terminal 30 and is received by the image forming apparatus 10. Since the operation of the information providing device 20 in this case is the same as that shown in FIG. 10, a description thereof is omitted here.

In this operational example, the MAC address contained in the discovery packet and the MAC address stored in the information storage unit 24 are compared with each other. Alternatively, IP addresses or host names may be compared instead of MAC addresses.

Furthermore, in this operational example, MAC addresses are compared since it is assumed that the discovery packet does not contain a user ID. Alternatively, if the discovery packet contains a user ID based on a protocol, user IDs may be compared instead of MAC addresses. Specifically, during user authentication, the positive-negative authentication determining unit 22 stores the user ID of the logged-in user into the information storage unit 24. In this case, the user ID is used as an example of first information, which is information related to the user. Furthermore, when the discovery packet is received, the discovery-response transmitting unit 26 compares the user ID contained in the discovery packet with the user ID stored in the information storage unit 24 and transmits a discovery response to the mobile terminal 30 only when these user IDs match. In this case, the user ID is used as an example of second information, which is information related to the owner of the print command device.

Alternatively, the discovery-response transmitting unit 26 may compare the user ID stored in the information storage unit 24 with the MAC address contained in the discovery packet, or compare the MAC address stored in the information storage unit 24 with the user ID contained in the discovery packet. This implies that a MAC address may be used as an example of second information when a user ID is used as an example of first information, or a user ID may be used as an example of second information when a MAC address is used as an example of first information. However, in either case, a process for acquiring a MAC address corresponding to a user ID based on the user ID or a process for acquiring a user ID corresponding to a MAC address based on the MAC address is performed at an appropriate timing.

Furthermore, the discovery-response transmitting unit 26 may determine whether the user performing a discovery request from the mobile terminal 30 is capable of logging into the apparatus based on information such as the user ID contained in the discovery packet, and may transmit a discovery response to the mobile terminal 30 only when the user is capable of logging in. Alternatively, the discovery-response transmitting unit 26 may determine whether the user performing a discovery request from the mobile terminal 30 is authorized to use the apparatus and may transmit a discovery response to the mobile terminal 30 only when the user is authorized.

Furthermore, in this operational example, when the authentication-information acquiring unit 21 acquires authentication information, a MAC address is acquired by connecting to the authentication server 50. Alternatively, for example, a configuration that acquires a MAC address by connecting to the authentication server 50 every time the discovery-response transmitting unit 26 transmits a discovery response may be employed. Another alternative is a configuration that acquires correspondence information between a user ID and a MAC address from the authentication server 50 at an arbitrary timing after activation of the image forming apparatus 10, stores the correspondence information into a storage unit within the image forming apparatus 10, and compares the MAC address stored in the storage unit of this image forming apparatus 10 with the MAC address contained in the discovery packet when a discovery response is to be transmitted. In that case, the discovery response may be transmitted when the user is authorized to log in instead of when the user set in correspondence with the MAC address is logged in.

In the third exemplary embodiment, the positive-negative authentication determining unit 22 authenticates a user by connecting to the authentication server 50. However, assuming that a user DB for user authentication exists within the image forming apparatus 10, a configuration that authenticates a user without connecting to the authentication server 50 may alternatively be employed.

A program that realizes each of the above exemplary embodiments may be provided not only by a communication unit but also by storing the program in a storage medium, such as a compact disc read-only memory (CD-ROM).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A print-command support device comprising:
an accepting unit that accepts user information related to a user of a printing apparatus;
an authenticating unit that authenticates the user based on the user information;
a receiving unit that receives request information from a print command device, which displays information related to a plurality of printing apparatuses and selects one printing apparatus from the plurality of printing apparatuses so as to command the one printing apparatus to perform printing, the request information being information for requesting transmission of the information related to the printing apparatus; and
a processing unit that performs a transmission process or a determination process in accordance with reception of the request information, the transmission process being a process for transmitting the information related to the printing apparatus and information related to authentication by the authenticating unit to the print command device, the determination process being a process for determining whether to transmit the information related to the printing apparatus to the print command device based on the information related to the authentication by the authenticating unit.

2. The print-command support device according to claim 1,
wherein when performing the transmission process, the processing unit transmits, to the print command device, information related to the user authenticated by the authenticating unit as the information related to the authentication.

3. The print-command support device according to claim 1,
wherein when performing the transmission process, the processing unit transmits, to the print command device, information related to the user capable of being authenticated by the authenticating unit as the information related to the authentication.

4. The print-command support device according to claim 1,
wherein when performing the determination process, the processing unit determines to transmit the information related to the printing apparatus to the print command device if information related to the user authenticated by the authenticating unit is stored as the information related to the authentication.

5. The print-command support device according to claim 1,
wherein when performing the determination process, the processing unit determines to transmit the information related to the printing apparatus to the print command device if information related to the user authenticated by the authenticating unit is not stored as the information related to the authentication.

6. A print-command support device comprising:
an accepting unit that accepts user information related to a user of a printing apparatus;
an authenticating unit that authenticates the user based on the user information;
a storage unit that stores first information, which is one of information related to the user authenticated by the authenticating unit and information related to a device belonging to the user authenticated by the authenticating unit;
a receiving unit that receives request information from a print command device, which displays information related to a plurality of printing apparatuses and selects one printing apparatus from the plurality of printing apparatuses so as to command the one printing apparatus to perform printing, the request information being information for requesting transmission of the information related to the printing apparatus and being information containing second information, the second information being one of information related to an owner of the print command device and information related to the print command device; and
a determining unit that determines whether to transmit the information related to the printing apparatus to the print command device in accordance with reception of the request information based on a comparison result between the first information and the second information.

7. A non-transitory computer readable medium storing a program causing a computer to execute a print-command support process, the process comprising:
accepting user information related to a user of a printing apparatus;
authenticating the user based on the user information;
receiving request information from a print command device, which displays information related to a plurality of printing apparatuses and selects one printing apparatus from the plurality of printing apparatuses so as to command the one printing apparatus to perform printing, the request information being information for requesting transmission of the information related to the printing apparatus; and
performing a transmission process or a determination process in accordance with reception of the request information, the transmission process being a process for transmitting the information related to the printing apparatus and information related to authentication by the authenticating to the print command device, the determination process being a process for determining whether to transmit the information related to the printing apparatus to the print command device based on the information related to the authentication by the authenticating.

8. A non-transitory computer readable medium storing a program causing a computer to execute a print-command support process, the process comprising:
accepting user information related to a user of a printing apparatus;
authenticating the user based on the user information;
storing first information, which is one of information related to the user authenticated by the authenticating and information related to a device belonging to the user authenticated by the authenticating;
receiving request information from a print command device, which displays information related to a plurality of printing apparatuses and selects one printing apparatus from the plurality of printing apparatuses so as to command the one printing apparatus to perform printing, the request information being information for requesting transmission of the information related to the printing apparatus and being information containing second information, the second information being one of information related to an owner of the print command device and information related to the print command device; and
determining whether to transmit the information related to the printing apparatus to the print command device in accordance with reception of the request information based on a comparison result between the first information and the second information.
